(19) United States
(12) Patent Application Publication
(10) Pub. No.: US 2009/0204446 A1
(43) Pub. Date: Aug. 13, 2009

(54) SYSTEMS AND METHODS FOR VALUATION OF LIFE INSURANCE POLICIES

(76) Inventors: David Bruce Simon, Chicago, IL (US); Stuart Kent Cornew, Winnetka, IL (US)

Correspondence Address: STROOCK & STROOCK & LAVAN LLP, 180 MAIDEN LANE, NEW YORK, NY, 10038, US

(21) Appl. No.: 12/366,163

(22) Filed: Feb. 5, 2009

Related U.S. Application Data
(63) Continuation of application No. 61/026,370, filed on Feb. 5, 2008.

(51) Int. Cl. G06Q 40/00; G06Q 50/00

(52) U.S. Cl. 705/4; 703/3; 705/38

(57) ABSTRACT

Computer systems and a computer-implemented method for valuing a life insurance policy in which a policy valuation program stored on a computer readable medium includes a data collection module and a life expectancy adjustment module, and a policy valuation module. In operation, according to one embodiment, the policy valuation computer program is operative to receive information related to a life insurance policy, initiate the data collection module programmed to communicate with one or more remote data repositories to search for and retrieve data related to mortality indicators for the insured, initiate the life expectancy adjustment module programmed to correlate the retrieved mortality indicators against mortality information to calculate an expected change in life expectancy based on the change in mortality, and calculate a value for the life insurance policy based on the expected change in life expectancy using the policy valuation module.

### CROSS-REFERENCE TO RELATED APPLICATIONS

The present application claims priority to Provisional Patent Application Ser. No. 61/026,370, filed Feb. 5, 2008, which is co-pending, and the entire disclosure of which is hereby incorporated by reference.

### BACKGROUND OF THE INVENTION

1. Field of the Invention

The present invention relates to systems and methods for marking to market the value of a life insurance asset and, in particular, to systems and methods that aggregate available information relating to the mortality of individuals and use such information to provide a monetary valuation for such life insurance asset, as well as systems and methods for producing title insurance as a repository of data of liens, calls on title, and insurance policies.

2. Description of the Related Art

When an individual seeks life insurance, the insurance company typically requires the individual to undergo an extensive underwriting process that includes a medical exam of the individual. The medical exam, as is widely known, is used to determine the life expectancy of the insured, which in turn is used to aid in determining the premium amount vis-á-vis the amount of the death benefit.

The life settlement market is an aftermarket in the life insurance industry that exists to permit an insured to sell their policy to a buyer and receive at least some of the death benefit prior to their death. The critical negotiation between the parties (i.e., the insured looking to transfer the death benefit and the party willing to pay some amount of money in return for the potential to receive the benefit) centers on the valuation of the present value (PV) of the policy. The formula for calculating PV is: Present Value=Future Cash Flow/(1+Required Rate of Return)^{Number of Years You Have To Wait For The Cash Flow}.

However, the present process of updating the value of the policy suffers from a number of technical problems for which an adequate technical solution has not been developed. Specifically, because time may have passed since the time the policy was originated, most purchasers will want to revalue the policy prior to purchase in the life settlement market. In order to value the existing policy, purchasers operating in the life settlement industry essentially have to repeat the extensive and costly process to underwrite and price the life insurance policy that is being purchased. Presently, this process first requires that the purchaser acquire the Attending Physicians Statement (APS) for the insured. Then, the purchaser must engage a life expectancy report provider such as 21st Services, American Viatical Services (AVS), Examination Management Services, Inc. (EMSI), Fasano Associates (Fasano), and ISC Services, to perform underwriting services based at least in part on the APS. After receiving the life expectancy report from such provider, the purchaser typically inputs certain insured-specific information about the policy, as well as information contained in the life expectancy report, into a computerized mortality-modeling program. The mortality-modeling program is designed to receive inputs for a stream of premiums for the policy and calculate the targeted return of the policy, and thereby calculate a price to be paid for the policy. This mortality evaluation and pricing process, which includes acquisition of an APS for the insured and the life expectancy report is both costly and inefficient in time and in money.

Moreover, this mortality evaluation and pricing process must typically be performed each time a policy is to be bought and sold in the secondary life settlement market as conditions may have changed with time. The costs and inefficiencies associated with this process have to date prevented the life settlement market from developing a meaningful free market for the trading and exchange of life insurance policies. Further, such costs and inefficiencies have made it difficult for various funds (e.g., hedge funds, mutual funds, or exchange traded funds, to name a few) to be developed, because there has heretofore been no way to quickly and efficiently revalue a group of insurance policies on a short term basis using an accepted valuation model. The need to acquire APS's and life expectancy reports for a large number of policies each time a fund was to be revalued (e.g., on a quarterly or monthly basis) would be cost prohibitive and would include a time delay element unacceptable to such markets. Consequently, such costs and inefficiencies have also prevented the securitization and indexing of groups of life policies.

Thus, there is a long felt, but unresolved, need in the art, and it is an object of the present invention to provide a methodology to eliminate the APS and life expectancy process when updating the value of the policy.

There are also a number of technical problems associated with updating and collecting the information necessary to revalue a policy, efficiently calculating a reliable life expectancy and thereby adjusting the present value of the policy.

### SUMMARY OF THE EMBODIMENTS

The embodiments of the present invention seek to overcome or mitigate some or all of the shortcomings and technical problems of the prior art. In general, one technical solution to the aforementioned technical problems is provided by an embodiment of a system for valuing a life insurance policy comprising a computer system, including one or more computers and databases, wherein the computer system is capable of communication with a network, such as the Internet, to permit the transmission and receipt of data. The computer system is generally capable of communicating and requesting and receiving certain information, as further described below, from one or more remotely located data repositories. Such information is used to collect data and adjust the life expectancy of the insured and thereby re-value the life insurance policy.

A method in accordance with an embodiment of the present invention generally includes the steps of: (i) initiating a policy valuation programming module; (ii) receiving information related to a selected policy to be valued, including insured specific information, an original life expectancy report, and premium information; (iii) retrieving credit information for the insured using at least a portion of the insured specific information; (iv) correlating the retrieved credit information against mortality information corresponding to changes in an insured's credit rating to calculate an expected change in life expectancy; (v) adjusting the life expectancy of the insured based on the expected change in life expectancy; and (vi) calculating a value for the policy based on the expected change in life expectancy, as well as the premium information. In addition, embodiments of the above-described method may include the steps of retrieving motor vehicle reports, as well as prescription and/or medical history information for the insured, and calculating an expected change in life expectancy based thereon.

In accordance with such embodiments, a computer-implemented method for valuing a life insurance policy for an insured using a policy valuation computer program stored on a computer readable medium operative in a computer system, wherein the computer system includes a processor, a network interface, and a data storage device, and wherein the policy valuation program includes a data collection module and a life expectancy adjustment module, and a policy valuation module, comprises: (a) receiving information related to the life insurance policy for the insured to be valued, the information including insured specific information, a mortality report, and premium information for the life insurance policy; (b) initiating the data collection module programmed to cause the computer system to communicate with one or more remote data repositories to perform a search for data related to one or more mortality indicators for the insured and to retrieve data for at least one of the mortality indicators for the insured; (c) initiating the life expectancy adjustment module programmed to cause the computer system correlate the retrieved mortality indicators against mortality information to calculate whether there is a change in mortality of the insured based on the retrieved mortality indicators and calculating an expected change in life expectancy based on the change in mortality; and (d) initiating the policy valuation module programmed to cause the computer system to calculate a value for the life insurance policy based at least in part on the expected change in life expectancy.

Advantageously, embodiments of the present invention can be performed using data sweeps on a pre-determined basis, e.g., on a daily, weekly, monthly or quarterly basis, at a very low cost when compared with the cost to gather all the APS's. Whereas the process of obtaining an updated APS and life expectancy reports cost approximately between $500 and $1,000, and take from 8-weeks to as much as 6-months, the valuation process of the present invention could be performed in a shorter timeframe, such as a 72-hour period or less and as often as desired for less than $100 per record.

As will be seen from the following discussion, the technological solutions to the shortcoming of the present state of the art and the advantages thereof could not be achieved through mere automation of present processes, but rather the technological solutions provide a platform to perform data collection, correlation and valuation functions not available except on a computerized system such as is described herein. Additional features and advantages of the system are described further below.

### BRIEF DESCRIPTION OF THE FIGURES

In the drawing figures, which are not to scale, and which are merely illustrative, and wherein like reference numerals depict like elements throughout the several views:

FIG. 1 is an overview of a system architecture in accordance with a preferred embodiment of the present invention;

FIG. 2 is a schematic of programming modules operative on a processing computer configured in accordance with a preferred embodiment of the present invention;

FIG. 3 is a flow diagram depicting a process for updating the value of a life insurance policy in accordance with preferred embodiments of the present invention;

FIG. 4a is an example of a dataset in chart form representative of a mortality curve representative of the total population at selected ages and a sub-curve for a particular health risk factor;

FIG. 4b is an example of a dataset in chart form representative of a mortality sub-curve for a combination of health risk factors;

FIG. 5 is a flow diagram depicting an embodiment of a process for calculating a life expectancy for an individual; and

FIG. 6 is a schematic of various networked systems for valuing a life insurance policy as part of a loan transaction.

### DETAILED DESCRIPTION OF THE PREFERRED EMBODIMENTS

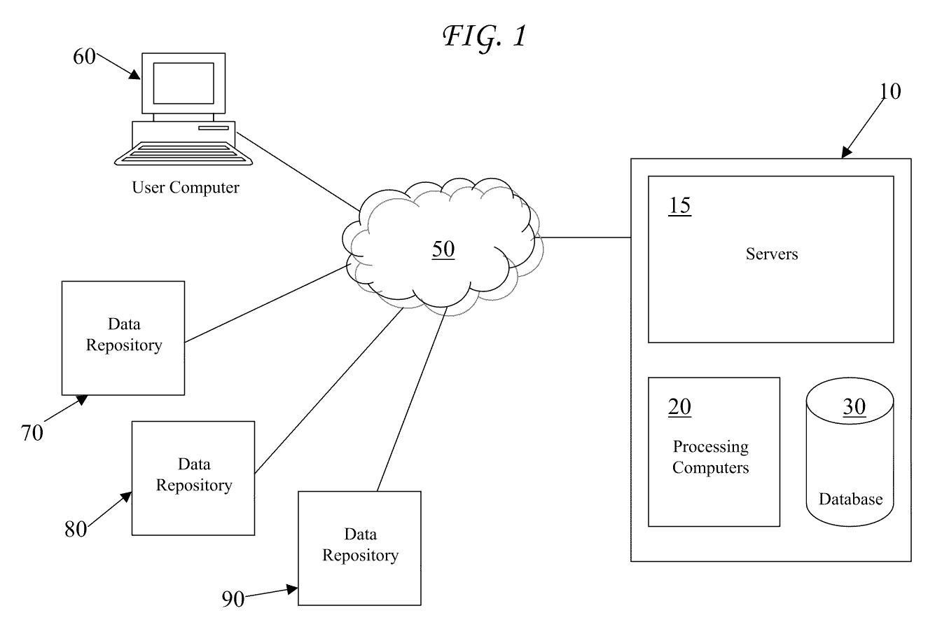

With reference to FIGS. 1-6, there is shown and described novel systems and methods for valuing life insurance policies through retrieval of insured specific information and without the need to obtain a new life expectancy report.

System Architecture

With reference to FIG. 1, there is shown a preferred embodiment of a system 10 designed and configured in accordance with the present invention. In general, from a functional viewpoint, the computer system 10 is generally configured and programmed to receive information corresponding to a life insurance policy, which information may include the age and sex of the insured, the insured's credit rating, the amount of death benefit, the original life expectancy and/or the carrier underwriting classification report, the premium amount, and certain insured specific information, including but not limited to smoker indication, prescription information, and general medical information (e.g., surgeries, treatments, etc.). The retrieved information is then used by the computer system to calculate a value for the life insurance policy based at least in part on the original life expectancy report and/or the carrier underwriting classification report, adjustments to the life expectancy of the insured, and the remaining stream of premiums. In the embodiment being discussed, the original life expectancy and/or carrier underwriting classification report serves as the baseline and thus the need to obtain a new life expectancy report is obviated.

Referring still to FIG. 1, a preferred embodiment of system 10 includes one or more servers 15 capable of communication with a network 50 through which one or more user computers 60 and/or one or more data repositories 70, 80, and 90 may be communicatively connected. Server 15 of system 10 is also preferably interconnected on a local or wide area network to one or more processing computers 20 and one or more database systems 30. It should be noted that although the embodiments described herein describe use of separate servers and databases for performing the various functions of the system 10, other embodiments could be implemented by storing the software or programming that operates the described functions on a single server or any combination of multiple servers as a matter of design choice so long as the functionality described herein is performed. Although not depicted in the figures, the server systems generally include such art recognized components as are ordinarily found in server systems, including but not limited to processors, RAM, ROM, clocks, hardware drivers, associated storage, and the like. One skilled in the art will recognize, however, that because multiple users may be accessing such servers at any given time it is preferable to utilize multiple servers and databases, which may be used separately or in tandem to support the systems traffic and processing, such as, by way of non-limiting example, a round-robin configuration utilizing multiple server systems.

Moreover, as will become evident from the following description and associated FIGS., end users—typically the insured or current owner of the policy—are in communication with the system 10 via a global communication network 50, such as for example, the Internet, cellular, satellite or other wireless communication network. End user computers 60 may be any type of personal or network computer such as an IBM-compatible computer running an Intel chipset and having an operating system, such as Microsoft Windows Vista, NT, 2000, XP, Apple operating system, and the like, and, preferably, running a browser program such as Microsoft Internet Explorer, Netscape Navigator, or Mozilla Firefox. It is also within the scope of the present invention that end user computers 60 may be handheld or table computing devices, such as a personal digital assistant (PDA), pocket PC, iPhone, and tablet PC, or the like. The end user computers 60 also preferably have access to a communications network via a modem or broadband connection to permit data communication between the end user computers and system 10.

Various input and output devices are also preferably provided with the end user computers 60 including, by way of non-limiting example, a display (e.g., cathode ray tube (CRT), liquid crystal display (LCD), etc.), and an input device (e.g., a keyboard, mouse, touch pad, or light pen). The end user computers 60 would also preferably include a storage device such as, for example, a magnetic disk drive and magnetic disk, a CD-ROM drive and CD-ROM, DVD, or other equivalent device.

Database system 30 of system 10 preferably includes one or more storage devices for storing a collection of information organized in such a way that processing computer 20 is able to access information related to the valuation of one or more life insurance policies. Processing computer 20 may be any type of personal or network computer such as an IBM-compatible computer running an Intel chipset and having an operating system, such as Microsoft Windows Vista, NT, 2000, XP, Apple operating system, and the like, and, preferably, running a browser program such as Microsoft Internet Explorer, Netscape Navigator, or Mozilla Firefox and is also preferably programmed with a database management system (DBMS) for providing access to the information stored on database system 30.

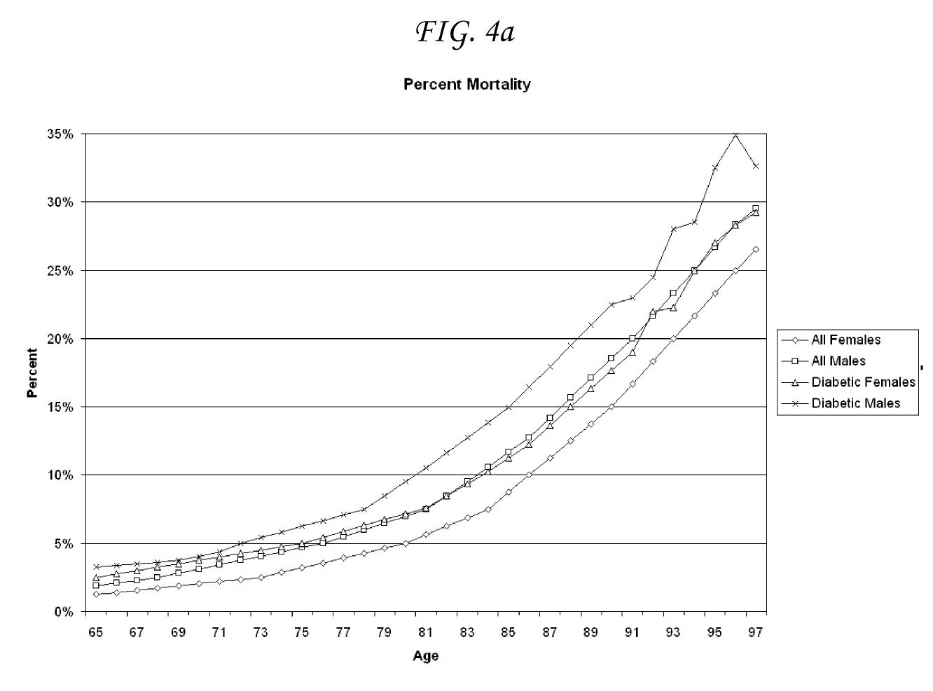

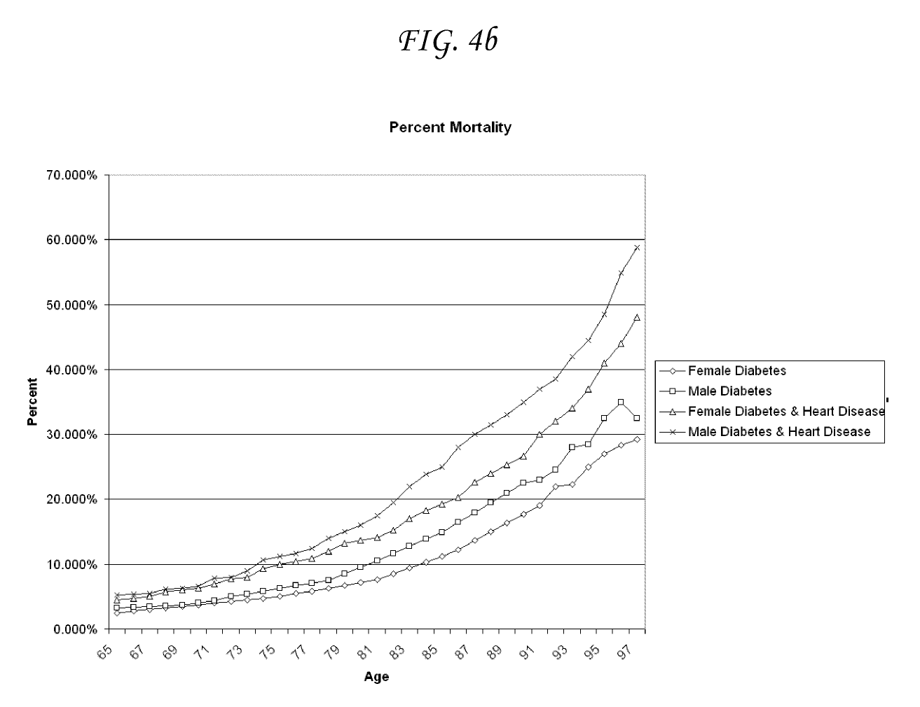

Database system 30 preferably includes information pertaining to various life insurance policies, information related to the insured, and data correlations to a plurality of mortality models (see, e.g. FIGS. 4a and 4b). For instance, positive or negative changes to an insured's life expectancy or mortality can be evaluated if known conditions, such as a particular disease exist. Specifically, if an insured is known to have diabetes, life expectancy can be expected to decrease according to various statistical models, while the same can be said of an insured that is a known smoker or has begun smoking since the initial life expectancy and/or the carrier underwriting classification report. If an insured is known to be both a smoker and have diabetes, then the life expectancy may be expected to decrease more than the sum of the conditions in accordance with such statistical models. Database system 30 preferably includes data that correlates a plurality of conditions to mortality statistics. As will be further described below, processing computer 20 is preferably designed and configured, through use of server 15, to retrieve up-to-date information about various events in an insured life from a plurality of available data repositories 70, 80, 90. Processing computer 20 is preferably further programmed to use the information stored in database system 30 to look-up relations between the retrieved events and known conditions that may affect mortality.

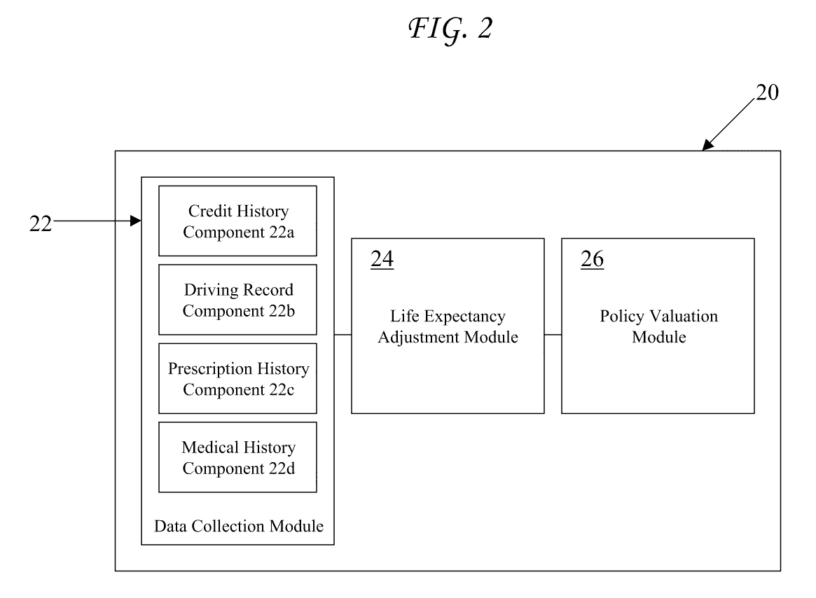

With reference to FIG. 2, processing computer 20 preferably includes programming comprising a data collection module 22, life expectancy adjustment module 24, and policy valuation module 26. Data collection module 22 preferably includes a credit history component 22a, a driving record component 22b, a prescription history component 22c, and a medical information component 22d. Life expectancy adjustment module 24, as will be further described below, preferably uses the original life expectancy or carrier underwriting classification report for the insured acquired at the start of the policy to establish a baseline value and then calculates one or more life expectancy additions or reductions (collectively, referred to as “life expectancy deltas”). The calculated life expectancy deltas can be programmatically passed to the policy valuation module 26 of processing computer 20. Policy valuation module 26 uses insured specific information, premium stream information, and the calculated life expectancy deltas to calculate a valuation for the policy being examined.

### Operational Example

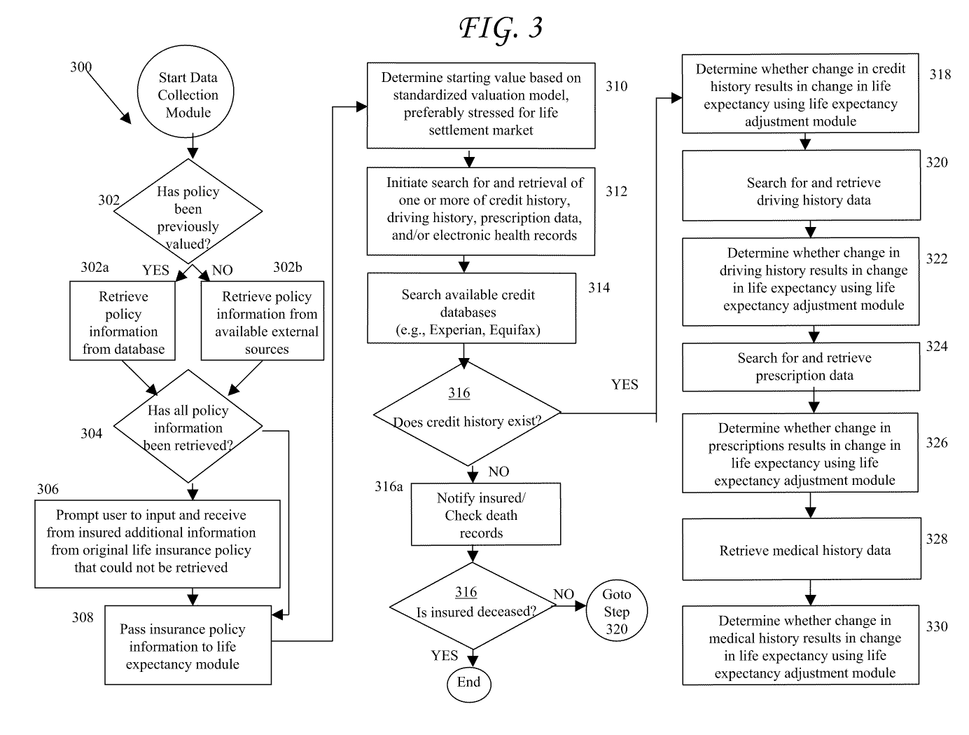

Referring now to FIG. 3, there will be described a preferred embodiment of updating the value of an insurance policy. First, in step 302, data related to the original policy, such as, by way of non-limiting example, name, sex, age and the other pertinent empirical data (premium stream), as well as the social security number or other identifying information of the insured, is retrieved by processing computer 20 from database system 30, in step 302a, if the policy is a previously valued policy, or through an external source/database containing such policy information, in step 302b. In step 304, processing computer 20 preferably determines whether any necessary information has yet to be collected. If processing computer 20 is unable to retrieve all of the necessary information from database system 30 or an external source, then processing computer 20 is preferably configured to prompt the insured or current owner of the policy to enter the remaining information, in step 306. For example, the insured desiring to sell the policy might use personal computer 60 to access the data collection module 22 of processing computer 20 through server 15 to input the same data that was input into the original pricing model for the policy. In addition, the original life expectancy and/or the carrier underwriting classification report for the insured is retrieved by processing system 20 from available sources.

The data collected by the above process can be advantageously harvested to, inter alia, publish indices usable by the entire industry to measure various industry performance indicators including, without limitation, life expectancy underwriters, disease, portfolio performance and other such measures. The data harvested is preferably used in a blind manner to protect clients and their private information, but to use the data to provide the industry with indices, indexes and performance data that can be used by nationally recognized statistical rating organizations, by portfolio managers, and by investors, both in the securitization of the asset as well as the measurement of investment performance and life expectancy underwriter performance in both the aggregate and by disease.

Once this information is input into data collection module 22, the information is passed to life expectancy adjustment module 24, in step 308. Life expectancy adjustment module 24 preferably utilizes known formulations for determining the life expectancy of an insured based on the information obtained in the original life expectancy and/or the carrier underwriting classification report and on the information mined during the data collection phase of the process. Life expectancy is typically expressed according to the following formula where eₓ is the life expectancy, and ₜPₓ is the probability of living from the current age (x) until some future age (x+t):

$${e}_{x} = {\sum }_{t = 1}^{∞} {}_{t}^{}{P}{}_{x}^{} + 0.5$$

One-half year is typically added to the life expectancy calculation to represent the experience that people typically survive halfway through the year of their expected death. The analysis to determine the probability of living from a current age (ₜPₓ) utilizes known mortality models, such as the Milliman model utilizing the 2001 VBT table, which may be stressed for the life settlement market as is known in the industry by persons of skill in the art. It will also be understood that the process of stressing the 2001 VBT Table is typically based on proprietary, non-public models, and that such non-public models can be used within the spirit of the invention without resort to any specific stressing model. It is also with the scope of the invention that purchasers using the present invention will have the ability to further adjust the life expectancy model to incorporate their own evaluations based on their internal assumptions. Further, it will be understood that use of the 2001 VBT Table may be replaced with another life expectancy valuation table (e.g., the 2008 VBT Table recently released by the Society of Actuaries) or an updated or heretofore unreleased version of the 2001 VBT table by the Society of Actuaries or other entity.

Life expectancy adjustment module 24 begins its analysis, in step 310, with an appropriate mortality model as its base; in this example the 2001 VBT table or a chart similar to the one shown in FIG. 4a. The data contained in the VBT tables or other mortality models permit life expectancy module 24 to calculate a baseline life expectancy for an insured based on the insured's age at issuance of the policy and the number of years since the policies' issuance. While the VBT tables generally provide the foundation for such calculations, as noted above, industry participants typically stress the data contained in the VBT tables according to their own proprietary models. The specific data forming the basis of the life expectancy calculation is a matter of design choice.

Subsequent to or simultaneous with the collection of information related to the initial life insurance policy, in step 312, data collection module 22 attempts to retrieve insured information relating to one or more of the insured's credit history, driving history, prescription data, and electronic health records. Prescription data and electronic health records may be accessed through electronic data providers, such as Allscripts. By way of example, the data collection module 22 may use the social security number of the insured, as well as the date of the original life expectancy or carrier underwriting classification report that was first provided and perform a sweep of known credit information to identify any changes in credit from the date of the life expectancy or carrier underwriting classification report to the date of the valuation. Any identified positive or adverse shifts in the credit data for the insured are then correlated to a corresponding life expectancy delta.

According to a preferred embodiment, life expectancy (LE_{N}) may be thought of the baseline life expectancy calculation (LE_{b}) and any calculated change in life expectancy based on the data sweep described above (ΔLE):

LE_{N}=LE_{b}+ΔLE

Although changes in life expectancy may typically be assumed to be negative, i.e., increases in health risks, it will be understood that the value of ΔLE may be a net positive, i.e., improved health. Moreover, although the above expression implies that a specific value for ΔLE will be calculated, according to a preferred embodiment, life expectancy module 24, after relevant data is collected by data collection module 22, determines an updated value by cross-referencing the individual's age against the mortality curve using the appropriate sub-curve data. This process is described further below.

In one embodiment, a baseline life expectancy can be derived from information in the original life insurance policy. For instance, if an insured was underwritten with a “preferred” status, which may correspond to a particular Relative Risk (RR) level, the life expectancy for that insured at the time the policy was created can be derived by utilizing the appropriate VBT table for that RR level. The life expectancy is essentially the number of years (or months) from the origination date that 50% of the population at a particular age will die. For example, a male (age 65), non-smoker, and preferred status may have an RR equal to 70. If that policy was written in 2008, and the composite 2008 VBT tables were used to determine the life expectancy of the insured for purposes of calculating premium amounts, the baseline life expectancy for the insured would be approximately 248 months (20.67 years). However, using 2008 RR VBT Tables to account for the “preferred” status and RR equal to 70, the life expectancy increases to just over 252 months (˜21 years). For comparison purposes, a non-smoker with an RR equal to 140, which indicates certain health risks, the life expectancy would be approximately 220 months (18.33 years).

Taking the above example, and the 65-year old male with an RR equal to 70, the baseline LE is about 21 years. If that policy were to be revalued in year 10 (i.e., at age 75), using a preferred embodiment of the present invention, the LE would be reset to approximately 159-160 months. In order to adjust the LE according to health and other risk issues that may have arisen since the origination of the policy, data collection module 22 attempts to electronically retrieve available data that could impact the LE calculation. For example, in step 314, data collection module 22 attempts to determine whether a credit history for the relevant social security number (or other insured identifier) exists. Data correlating changes in credit history is available through several sources. Specifically, several mortality studies based on credit data, such as is set forth in the Credit Life Mortality and Minimum Valuation Standard paper, dated May 1, 2002, demonstrate the effect of credit changes on the mortality of an insured. In a preferred embodiment, such data can be mined to create a sub-curve to the standard or customized VBT curves or other mortality data source, such that a change in the insured's credit information will be evaluated by correlating the credit change to a change in mortality using the credit sub-curve. Use of credit change-to-mortality correlation data in this fashion may produce a related life expectancy delta, which will in turn change the value of the policy.

The type of credit events that most notably cause an adverse change in the credit of an insured and thereby a corresponding life expectancy delta, would include bankruptcies foreclosures, seizures, collection proceedings, or other like proceedings brought against the insured. In the preferred embodiments, changes in the FICO score or other similar credit score also would be correlated to a life expectancy delta on a sub-curve to the appropriate VBT or other mortality curve. For example, positive changes to the credit score or positive credit events can have a positive effect on the life expectancy delta, and vice versa.

Turning back to the description of a preferred embodiment of updating the LE value, with reference to FIG. 3, in step 314, available credit databases are searched for potential changes in the credit of the insured. If the social security number fails to return a credit report, in step 316, the system 10 is preferably programmed to notify the insured or to check available death records in situations where the insured did not initiate the valuation process, in step 316(a). If there is no credit history, but the insured is found to be alive, then, in steps 320-330, the program preferably attempts to retrieve motor driving and vehicle, prescription, medical history data. If credit history exists, then the data collection module 22 passes the credit history to life expectancy adjustment module 24, in step 318, for a determination as to whether there is a corresponding change in life expectancy. Reports may also be generated to indicate that there was no change due to credit history or to note that the credit history sweep failed. In a preferred embodiment, a confidence report may also be issued to indicate the confidence level in the accuracy of the valuation report. The higher the level the more confidence in the valuation. For instance, a “Level One Confidence Report” would indicate that the credit history sweep failed. A “Level Two Confidence Report” would report that the system 10 successfully updated credit information only, but that there was no change in the credit information and, therefore, no change from the original valuation of the policy except to age the policy along the original VBT or other mortality curve. Thus, by way of a non-limiting example, if the system 10 started with a ten (10) year life expectancy and the system is re-valuing the policy at the end of one-year, the system 10 would, for example, simply move along the standard VBT or other mortality curve one-year.

After the data collection module 22 performs the credit sweep, as noted above, data collection module 22 will perform a sweep of available driving and motor vehicle and prescription and medical history databases, such as Allscripts, and will determine whether there have been any changes in the insured's driving record and/or prescriptions and/or medical history. It is preferred that the data sweep attempts to obtain data for the insured going back to the date of the original life expectancy or carrier underwriting classification report and determine whether any such changes resulted in a change in life expectancy (steps 320-330).

As noted above, in a preferred embodiment, a second sweep may be performed by the data collection module 22 of the processing computer 20. A “Level Three Confidence Report” may be issued to indicate a successful sweep of available credit and driving history/motor vehicle records. A “Level Four Confidence Report” may be issued to indicate a successful sweep of available credit, driving history/motor vehicle records, and prescription data. Presently, it is anticipated that the system 10 will achieve a 20-30% hit rate on sweeps for an insured's prescription data. It is further anticipated that by the year 2014, the system 10 will achieve close to a 70% hit rate increasing to close to 100% by 2019. If prescription data for a particular insured is retrieved by the data collection module 22, then the prescription information is passed to the life expectancy adjustment module 24 for a determination as to whether there is a correlation between prescription data and a known mortality factor. For instance, if there is a change in the prescription, including, without limitation, an increase or decrease in dosage of a prior prescription, a change in the frequency of a prior prescription or a new prescription being prescribed, the life expectancy adjustment module 24 is programmed to retrieve mortality data correlations with the perceived change in prescription information. For instance, a drug that was previously prescribed would be re-valued for its affect on mortality. Similar to the modeling of changes in credit information, the life expectancy adjustment module 24 would track a life expectancy delta on a sub-curve to the VBT standard or other mortality curve being used. Each sub-curve would track a specific disease correlated to a prescription or a combination of diseases related thereto, as described further below.

According to a preferred embodiment of the present invention, the data collection module 22 seeks to retrieve medical history information for the insured. Currently, less than five percent of the market makes electronic health records available. In one embodiment, the insured is asked to update their medical history. In another embodiment, an individual working for or on behalf of the entity seeking the valuation of the life insurance policy will manually check electronic health records to update an individual's medical history. In a preferred embodiment, however, an electronic search engine, which may be configured to operate as part of the data collection model 22 of programming computer 20, is programmed to scan for certain keywords in medical history records for the insured, so as to retrieve information regarding changes in the health of an individual. Currently, there are not presently known standards for the entry of medical events. Thus, a comprehensive searching strategy using permutations of surgery-specific or disease specific conditions may be utilized to increase the accuracy of the search. In operation, the data collection model 22 searches for electronic health records from the date of the original life expectancy report. If the system is successful in retrieving credit data, driving history data, prescription data, and electronic health records, the valuation will receive a “Level Five Confidence Report”.

Life Expectancy Re-Evaluation

At the end of the data collection process described in connection with FIG. 3 above, life expectancy adjustment module 24 preferably utilizes the data collection concerning credit, driving and/or motor vehicle history (DMV), prescription, and health records for an insured to reevaluate the life expectancy of the insured. Changes in the expected life expectancy will be used to calculate a value for the life insurance policy.

In a preferred embodiment, as shown in FIGS. 4a and 4b, life expectancy adjustment module 24 uses a library of mortality sub-curves to evaluate the expected LE for the insured and to thereby value the policy. It is preferable that mortality sub-curves be developed for a variety of risk factors, such as credit changes, health changes, and combinations of disease factors. By way of example, as shown in FIG. 4a, mortality sub-curve 450 depicts the mortality curve for individuals starting at age 65 as compared with similarly aged individuals having been diagnosed with diabetes. It has been found by the inventors that certain combinations of diseases would also have specialized sub-curves to show that the combination of the two diseases corresponding to a particular prescription or group of prescriptions has a net mortality affect greater than the sum of the two diseases individually. In presently known methods of evaluating changes in LE, various risk factors are identified and then added together. In accordance with a preferred embodiment of the present invention, specific sub-curves that track mortality of individuals with specified combinations of risk factors could be used in lieu of the traditional summing methods. By way of further example, as shown in FIG. 4b, mortality sub-curve 455 depicts the mortality curve for individuals starting at age 65 as compared with similarly aged individuals having been diagnosed with diabetes and heart disease.

During the data collection process described above, the system 10 may have retrieved data indicating that the individual was suffering from both risk factors. According to a baseline mortality curve, such as the 2008 VBT tables, the individuals LE would be approximately 17-years. If more traditional methods of summing the effects of multiple risk factors are used, the LE might decrease by a number of years greater than the true combined effect of the risk factors. However, using a sub-curve developed from specific mortality data for persons actually having such a risk factor combination indicates an LE of approximately 11-years—far less than the results derived from summing methods. This is believed to be because multiple risk factors have an impact on the health of an individual that exceeds the mortality probabilities created by having one or the other risk factors.

With reference again to FIG. 4b, mortality sub-curve 450, which depicts the mortality curve for a 65-year old individual with both diabetes and heart disease, may use data made available by the United States Government through various organizations. It has been found that mortality data for Medicare patients, which is provided on a “blind” basis, is a preferred source of mortality data and provides a robust dataset for various diseases. Presently, there are 6-8 diseases with sufficient mortality data to model. However, persons of skill in the art will recognize that as further data is developed the present invention may be used in connection with any number of disease-specific sub-curves. FIG. 4b depicts a chart representative of data for the years 2000 through 2006. The data provides a sampling of Medicare participants at various ages and indicates the number of deaths as a percentage of total population at that age.

In accordance with the above, a preferred embodiment of selecting and analyzing appropriate mortality data will not be described. As discussed, a preferred embodiment involves using Medicare claims data and demographic data to build tables showing survival curves (or mortality curves) for individuals of different ages and with a variety of medical problems. These tables can be used to screen and price individual policies or portfolios of policies being offered for purchase. In addition to survival curves, in a preferred embodiment, the data for patterns of clinical and demographic factors related to mortality (or survival) for people of various ages and with various diseases will be analyzed. Claims and demographic data will preferably be used to determine the effect on mortality of the diseases, both individually and in combination, by examining the mortality rates of people with the diseases alone and in combination.

Data for the creation of mortality sub-curves is preferably obtained from the United States Department of Health and Human Services (HHS) Centers for Medicare & Medicaid Services (CMS). The data sets are generally known as Limited Data Set Files (LDS) and are provided on a “blind” basis to avoid identification of beneficiaries. The files contain beneficiary level health information. The data are of 2 types—demographic data, and claims data.

There are several known methods for evaluating life expectancy and underwriting life insurance policies. One way is to use a knockout or edge approach. Another is to use a debit/credit method. It is within the scope of the present invention to utilize both methods or any other proprietary method of evaluating life expectancy. The knockout approach attempts to evaluate the health of an individual based on certain criteria and will place an individual into a higher risk class if that individual fails to meet certain criteria for a particular risk class, typically starting at the preferred level. A debit/credit approach applies a number of debits or credits for each specific risk level and adds the debits and credits at the end of the evaluation in order to place the individual into a particular risk class. For purposes of illustrating the present invention, use of the knock-out method will be described.

In a preferred embodiment, life expectancy adjustment module 24 uses the data collected in prior steps to calculate a risk factor score for the individual. This score can be calculated according to known algorithms, such as the revised Underwriting Criteria Score (UCS) made available through the Society of Actuaries, or a proprietary scoring algorithm. It is presently preferred that a UCS score be calculated using both the information originally provided by the insured at the time of policy issuance and the data collected by data collection module 22. Once a UCS score is calculated, the UCS score can be related to a corresponding Relative Risk Ratio (RRR) using, for example, correlation tables available through the Society of Actuaries. The table below is an example of a correlation table available as part of the release of the 2008 VBT tables:

Relative Risk Table and Corresponding Specific UCS

| Smoking Status | Relative Risk Table (RR Table) | Specific UCS |
|---|---|---|
| Non-smoker | 70% | 36 |
| Non-smoker | 80% | 51 |
| Non-smoker | 90% | 64 |
| Non-smoker | 100% | 76 |
| Non-smoker | 110% | 87 |
| Non-smoker | 120% | 98 |
| Non-smoker | 130% | 106 |
| Non-smoker | 140% | 113 |
| Non-smoker | 150% | 119 |
| Non-smoker | 160% | 123 |
| Smoker | 75% | 44 |
| Smoker | 100% | 76 |
| Smoker | 125% | 103 |
| Smoker | 150% | 119 |

Using the chart above, a specific UCS score determined through an updating of the insured's risk factors, as described in detail above, can be correlated to a specific RR. Using the correlated RR, an appropriate VBT or other type of mortality table, for example, can be used to determine the insured's updated LE.

Each of the above-described methods of using the updated risk factor information can be used in whole or in part to determine an updated value for a policy. It will be recognized that the technical problem of efficiently and relatively quickly updating policy values can be overcome by employing the technical solution described herein to electronically capture insured risk data and calculate updated policy values.

In another feature of a preferred embodiment of the present invention, system 10 is programmatically designed to periodically update and track an insured's risk factor progress. Specifically, in embodiments using a sub-curve method, as polices fall to a disease sub-curve due to information being captured indicating that the insured has developed a disease, the policy may increase in value. Although, as time passes, if the prescribed treatment or medication is in fact working, updated information as may be collected through data collection module 22 may indicate an improving condition. In such cases, the individual may return to the base VBT or other mortality table, thereby returning the value of the policy closer to its original value along the relevant mortality curve. For example, in the case of breast cancer, when first discovered, the mortality evaluation and calculation of LE will preferably be based on a cancer sub-curve; however, as time passes (e.g., 5-years later), if information indicates that the insured's condition has remained stable or improved, and prescription data indicates the use of a drug such as Tomoxifan, mortality data may indicate that the insured's LE outlook is better defined by the base table rather than the sub-curve.

As an additional feature, the data collected by the system 10 over time can be used to re-evaluate the accuracy of the original life expectancy report. For instance, if a particular life expectancy report is issued to in respect of a gentleman who has heart disease of ten years and data collected over time reveals that that provider mis-underwrote heart disease in other life expectancy reports by one-year, the system 10 would preferably be programmed to adjust the original life expectancy report by that one-year such that the original report would have been eleven years and therefore be more accurate.

Specific Applications

A. Mortgages

In one application of a preferred embodiment of the present invention, a system 10 is utilized in connection with complete or partial satisfaction of a mortgage or other loan product. For example, Mr. U is a homeowner that has gotten behind on his mortgage payments and is being contacted by a workout team at his mortgage holder. Mr. U has no other significant assets that he feels comfortable utilizing to pay the mortgage. As an alternative to defaulting on the mortgage, and to avoid foreclosure on his home, Mr. U can assign his life insurance policy to the mortgage lien holder or other buyer and then use the proceeds from the sale as complete or partial satisfaction of the loan. This requires a valuation of the policy in an efficient and rapid manner.

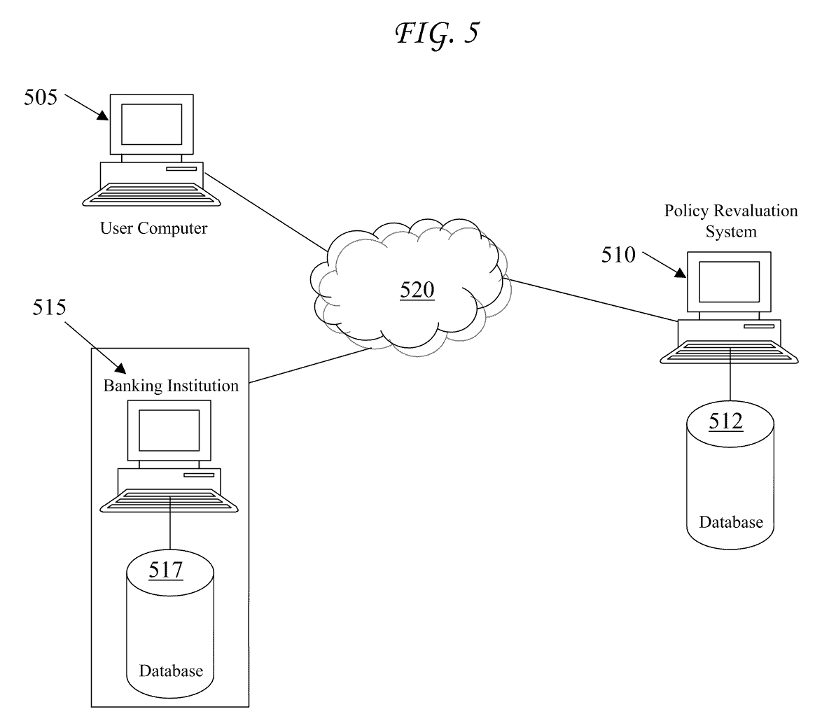

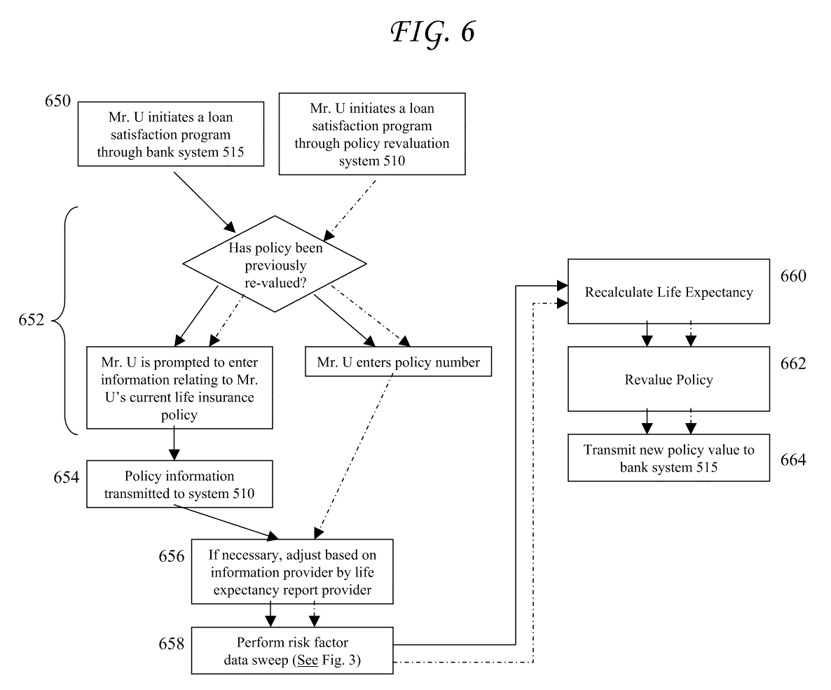

With reference to FIGS. 5 and 6, a preferred schematic of various networked systems are shown and a computerized process for electronically using a life insurance policy to at least partially satisfy a mortgage loan will now be described. As shown in FIG. 5, policy revaluation system 510, and related database 512, are communicatively connected via network 520 with banking institution system 515 (and its database 517) and one or more user computers 505. Turning now to FIG. 6, in step 650, using user computer 505, Mr. U initiates a loan satisfaction program through bank computer 515. Alternatively, the policy re-valuation process can be initiated directly with system 510. In step 652, Mr. U is prompted to enter information relating to Mr. U's current policy or, alternatively, enters a policy identifier that can be used by system 510 to access policy information in database 512. In step 654, policy information is transmitted to system 510. System 510 using the policy information, and particularly information concerning the life expectancy report provider, in step 656, adjusts the original life expectancy report accordingly. By way of example, 21st Services announced recently that an error in their life expectancy methodology and curves caused their life expectancy reports to be off by approximately 25%. System 510 would preferably take this into account and adjust the original life expectancy period accordingly. Thus, if Mr. U had a life expectancy report from 21st Services indicating a 120-month life expectancy when the policy was sold, system 610 would preferably make a 25% adjustment to reset the life expectancy to 150-months.

In step 658, system 510 performs a data sweep and described and shown in connection with FIG. 3. Using information from the data sweep, system 510, in step 660, recalculates a life expectancy that accounts for any provider-based adjustments and any relevant change in health risk factors. In step 662, system 510 then revalues the value of the policy. The policy can be revalued using known deterministic or probabilistic valuation methods. The exact method used to revalue a policy based on updated information is a matter of design choice, although it is preferred that a probabilistic approach is used. In step 664, the new policy value is transmitted to bank system 515 for the loan satisfaction process. For example, the policy or its sale proceeds can be assigned to the bank to pay-off some or all of the principal remaining on the loan.

B. Hospital Bill/Healthcare Payment

In another example, a similar methodology as described above in the mortgage example can be used to help Mr. U pay for an uninsured medical procedure. In this example, Mr. U goes into a hospital for a procedure, emergency or otherwise. He has no other significant asset to pay for the procedure. The hospital can use electronically interact with system 610 to calculate an updated value for Mr. U's life insurance policy. The hospital can either have a policy purchased or can hold a portion of the death benefits as its payment for the operation.

C. Investment Hedging

The present invention advantageously provides an ability for an investor in life insurance policies to relatively quickly and efficiently value a plurality of policies in an effort to identify areas of risk exposure or to identify potential ways to balance a portfolio of policies to thereby hedge risk. For example, if an investor has a portfolio heavily invested in heart disease, the valuation procedures of the present invention will open up the ability to trade policies of similar value, but with varying risk exposures. Thus, the investor may choose to trade a policy exposed to heart disease for a policy exposed to a type of cancer. On the other hand, if an investor is over-exposed to a life expectancy report provider, such as AVS, the investor could value and trade for policies written by another provider, like Fasano.

D. Life Insurance Policy Markets; Indexes

As will be appreciated, the efficient and cost effective valuation process will enable new trading markets in the life settlement industry to emerge, as well as the ability to create funds of life policies. As these markets become developed, an electronic exchange where people can trade their life settlement policies as an asset will enable the liquidity in the life settlement market to increase. Further, the development of trading markets will enable various indexes based on life insurance policies to be created and efficiently valued. It is also anticipated that insurance carriers will be able to trade their mortality curves to the life settlement industry, as well as participate in lifetime annuities where they are already short mortality.

E. Carrier Re-Valuation

The ability to electronically update the value of a life insurance policy may also be utilized by life insurance carriers. In operation, by revaluing its own policies, carriers could provide an alternative way for insureds to sell their policies. The revaluation option would preferably be provided as a non-forfeiture option to the policyholder. As a condition, the carriers would preferably obtain continuing consents to release of protected health information under HIPAA, as in the current life settlement market, or in the alternative, include a provision in the contract that, at the request of the client, the carrier could obtain an updated valuation. By permitting carriers to electronically update the value of the life insurance policies it has written, both the insured and the carrier may take advantage of increases in the value of the policy without subjecting the policy to the life settlement market. More specifically, this embodiment of the present invention provides an advantage to the insurance carrier because the carrier may be able to purchase the policy from the insured at below-market prices without incurring the significant distribution costs currently associated with the purchase of a policy. In turn, by avoiding such costs and by performing the purchase with the carrier, the insured may obtain greater value for the policy and avoid the process of attempting to sell a policy on the life settlement market.

F. Title Insurance for Life Insurance Policies

In another aspect of the embodiments of the present invention, the depository of data would form the basis for an entity in the life settlement industry that operated analogous to title insurance companies in the real estate industry. In particular, owner of policies would enter information into programming computer 20 concerning their ownership interest in a plurality of life insurance policies, which information would then be stored in database system 30. The entity with access to the programming computer 20 would thereby act as a title agent for the insurance policy, such that anytime the policy is transferred, the entity could close the transaction by issuing a “title” insurance policy much like at a real-estate closing. This can be accomplished with offices that are open much like title insurance companies through out the land, or electronically on a web-based system. Such insurance will help the securitization market by providing comfort to purchasers that they are obtaining clean title to the policy. The “title insurance” process may be coordinated with life insurance companies to verify initial policy ownership, remove liens and waive clouds on title such as insurable interest or other recession risks.

In sum, the various embodiments of the present invention and their respective applications may incentive life insurance companies to increase participation in the life settlement markets, so as to hedge their life insurance portfolio and achieve a myriad of other investment objectives. Ultimately, industry-wide participation in the life settlement market, such as is contemplated hereby, may obviate the need for reinsurance and instead create efficient market pricing of death benefits.

Thus, while there have been shown and described fundamental novel features of the invention as applied to the embodiments thereof, it will be understood that omissions and substitutions and changes in the form and details of the disclosed invention may be made by those skilled in the art without departing from the spirit of the invention.

1. A computer-implemented method for valuing a life insurance policy for an insured using a policy valuation computer program stored on a computer readable medium operative in a computer system, wherein the computer system includes a processor, a network interface, and a data storage device, and wherein the policy valuation program includes a data collection module, a life expectancy adjustment module, and a policy valuation module, the method comprising:
(a) receiving information related to the life insurance policy for the insured to be valued, the information including insured specific information, a mortality report, and premium information for the life insurance policy;
(b) initiating the data collection module programmed to cause the computer system to communicate with one or more remote data repositories to perform a search for data related to one or more mortality indicators for the insured and to retrieve data for at least one of the mortality indicators for the insured;
(c) initiating the life expectancy adjustment module programmed to cause the computer system correlate the retrieved mortality indicators against mortality information to calculate whether there is a change in mortality of the insured based on the retrieved mortality indicators and calculating an expected change in life expectancy based on the change in mortality; and
(d) initiating the policy valuation module programmed to cause the computer system to calculate a value for the life insurance policy based at least in part on the expected change in life expectancy.

2. The method of claim 1, wherein the mortality indicator is a change in credit information for the insured.

3. The method of claim 2, wherein the change of credit indicates a drop in FICO score.

4. The method of claim 2, wherein the change of credit indicates a bankruptcy.

5. The method of claim 1, wherein the mortality indicator is a change in motor vehicle driving history for the insured.

6. The method of claim 5, wherein the change in motor vehicle driving history relates to one or more moving violations.

7. The method of claim 5, wherein the change in motor vehicle driving history relates to one or more accidents.

8. The method of claim 1, wherein the mortality indicator is prescription information for the insured.

9. The method of claim 8, wherein the prescription information is indicative of a disease.

10. The method of claim 1, wherein the mortality indicator is medical history information for the insured.

11. The method of claim 10, wherein the medical history information is indicative of performance of a medical procedure.

12. The method of claim 1, wherein the method is performed on a predetermined schedule.

13. The method of claim 12, wherein the predetermined schedule is weekly.

14. The method of claim 12, wherein the predetermined schedule is monthly.

15. The method of claim 12, wherein the predetermined schedule is quarterly.

16. The method of claim 1, wherein the method is performed close in time to a transaction involving the life insurance policy.

17. The method of claim 16, wherein the transaction is a purchase of the policy by a third party.

18. The method of claim 16, wherein the transaction is a loan transaction using the life insurance policy as at least part collateral.

19. The method of claim 1, wherein the remote data repositories include one of a credit bureau, a department of motor vehicles, a prescription database, and a medical history database.

20. The method of claim 1, wherein the mortality report is a life expectancy report.

21. The method of claim 20, wherein the life expectancy report is an attending physicians statement.

22. The method of claim 1, wherein the mortality report is a carrier underwriting classification report.

23. The method of claim 1, wherein the mortality information is a valuation basic table.

24. The method of claim 23, wherein the valuation basic table is the 2001 VBT table.

25. The method of claim 23, wherein the valuation basic table is the 2008 VBT table.

26. The method of claim 23, wherein the valuation basic table is selected based on a relative risk ratio.

27. The method of claim 1, wherein the mortality information is based on information collected from Medicare data.

28. The method of claim 1, further comprising transmitting the value to a remote computer system to enable the remote computer system to underwrite a loan to the insured using the life insurance policy as collateral.

29. The method of claim 28, wherein the remote computer system is operated by a banking institution.

30. The method of claim 28, wherein the loan is a mortgage.

31. The method of claim 28, wherein the loan is to refinance an existing mortgage.

32. The method of claim 28, wherein the loan is a personal loan.

33. The method of claim 28, wherein the remote computer is operated by a health care provider.

34. The method of claim 33, wherein the proceeds will be used to pay for health care services.

35. A computer system for valuing a life insurance policy for an insured, the computer system comprising:
a computer including a processor, a network interface, and computer usable medium storing a computer readable policy valuation program, wherein the computer readable policy valuation program includes a data collection module, a life expectancy adjustment module, and a policy valuation module;
a data storage system in communication with the computer via the network interface, the data storage system storing mortality information relating to mortality rates for individuals at selected ages and for individuals having one or more health risk factors; and
wherein the computer, operative with the computer readable policy valuation program, is configured to:
(a) receive information related to the life insurance policy for the insured to be valued, the information including insured specific information, a mortality report, and premium information for the life insurance policy;
(b) initiate the data collection module programmed to cause the computer system to communicate with one or more remote data repositories to perform a search for data related to one or more mortality indicators for the insured and to retrieve data for at least one of the mortality indicators for the insured;
(c) initiate the life expectancy adjustment module programmed to cause the computer system correlate the retrieved mortality indicators against the mortality information to calculate whether there is a change in mortality of the insured based on the retrieved mortality indicators and calculating an expected change in life expectancy based on the change in mortality; and
(d) initiate the policy valuation module programmed to cause the computer system to calculate a value for the life insurance policy based at least in part on the expected change in life expectancy.

36. The system of claim 35, wherein the mortality indicator is a change in credit information for the insured.

37. The system of claim 36, wherein the change of credit indicates a drop in FICO score.

38. The system of claim 36, wherein the change of credit indicates a bankruptcy.

39. The system of claim 35, wherein the mortality indicator is a change in motor vehicle driving history for the insured.

40. The system of claim 39, wherein the change in motor vehicle driving history relates to one or more moving violations.

41. The system of claim 39, wherein the change in motor vehicle driving history relates to one or more accidents.

42. The system of claim 35, wherein the mortality indicator is prescription information for the insured.

43. The system of claim 42, wherein the prescription information is indicative of a disease.

44. The system of claim 35, wherein the mortality indicator is medical history information for the insured.

45. The system of claim 44, wherein the medical history information is indicative of performance of a medical procedure.

46. The system of claim 35, wherein the system revalues the life insurance policy on a predetermined schedule.

47. The system of claim 46, wherein the predetermined schedule is weekly.

48. The system of claim 46, wherein the predetermined schedule is monthly.

49. The system of claim 46, wherein the predetermined schedule is quarterly.

50. The system of claim 35, wherein the method is performed close in time to a transaction involving the life insurance policy.

51. The system of claim 50, wherein the transaction is a purchase of the policy by a third party.

52. The system of claim 50, wherein the transaction is a loan transaction using the life insurance policy as at least part collateral.

53. The system of claim 35, wherein the remote data repositories include one of a credit bureau, a department of motor vehicles, a prescription database, and a medical history database.

54. The system of claim 35, wherein the mortality report is a life expectancy report.

55. The system of claim 54, wherein the life expectancy report is an attending physicians statement.

56. The system of claim 55, wherein the mortality report is a carrier underwriting classification report.

57. The system of claim 35, wherein the mortality information is a valuation basic table.

58. The system of claim 57, wherein the valuation basic table is the 2001 VBT table.

59. The system of claim 57, wherein the valuation basic table is the 2008 VBT table.

60. The system of claim 57, wherein the valuation basic table is selected based on a relative risk ratio.

61. The system of claim 35, wherein the mortality information is based on information collected from Medicare data.

62. The system of claim 35, further comprising transmitting the value to a remote computer system to enable the remote computer system to underwrite a loan to the insured using the life insurance policy as collateral.

63. The system of claim 62, wherein the remote computer system is operated by a banking institution.

64. The system of claim 62, wherein the loan is a mortgage.

65. The system of claim 62, wherein the loan is to refinance an existing mortgage.

66. The system of claim 62, wherein the loan is a personal loan.

67. The system of claim 62, wherein the remote computer is operated by a health care provider.

68. The system of claim 67, wherein the proceeds will be used to pay for health care services.

69. A computer program product, comprising a computer usable medium having a computer readable program code embodied therein, said computer readable program code adapted to be executed to implement a method for valuing a life insurance policy for an insured, said method comprising:
providing a system, wherein the system comprises distinct software modules, and wherein the distinct software modules comprise a data collection module, a life expectancy adjustment module, and a policy valuation module;
receiving information related to the life insurance policy for the insured to be valued, the information including insured specific information, a mortality report, and premium information for the life insurance policy;
initiating the data collection module programmed to cause the computer system to communicate with one or more remote data repositories to perform a search for data related to one or more mortality indicators for the insured and to retrieve data for at least one of the mortality indicators for the insured;
initiating the life expectancy adjustment module programmed to cause the computer system correlate the retrieved mortality indicators against mortality information to calculate whether there is a change in mortality of the insured based on the retrieved mortality indicators and calculating an expected change in life expectancy based on the change in mortality; and
initiating the policy valuation module programmed to cause the computer system to calculate a value for the life insurance policy based at least in part on the expected change in life expectancy.

70. The system of claim 69, wherein the mortality indicator is a change in credit information for the insured.

71. The system of claim 70, wherein the change of credit indicates a drop in FICO score.

72. The system of claim 70, wherein the change of credit indicates a bankruptcy.

73. The system of claim 69, wherein the mortality indicator is a change in motor vehicle driving history for the insured.

74. The system of claim 73, wherein the change in motor vehicle driving history relates to one or more moving violations.

75. The system of claim 73, wherein the change in motor vehicle driving history relates to one or more accidents.

76. The system of claim 69, wherein the mortality indicator is prescription information for the insured.

77. The system of claim 76, wherein the prescription information is indicative of a disease.

78. The system of claim 69, wherein the mortality indicator is medical history information for the insured.

79. The system of claim 78, wherein the medical history information is indicative of performance of a medical procedure.

80. The system of claim 69, wherein the system revalues the life insurance policy on a predetermined schedule.

81. The system of claim 80, wherein the predetermined schedule is weekly.

82. The system of claim 80, wherein the predetermined schedule is monthly.

83. The system of claim 46, wherein the predetermined schedule is quarterly.

84. The system of claim 80, wherein the method is performed close in time to a transaction involving the life insurance policy.

85. The system of claim 84, wherein the transaction is a purchase of the policy by a third party.

86. The system of claim 84, wherein the transaction is a loan transaction using the life insurance policy as at least part collateral.

87. The system of claim 69, wherein the remote data repositories include one of a credit bureau, a department of motor vehicles, a prescription database, and a medical history database.

88. The system of claim 69, wherein the mortality report is a life expectancy report.

89. The system of claim 88, wherein the life expectancy report is an attending physicians statement.

90. The system of claim 89, wherein the mortality report is a carrier underwriting classification report.

91. The system of claim 69, wherein the mortality information is a valuation basic table.

92. The system of claim 91, wherein the valuation basic table is the 2001 VBT table.

93. The system of claim 91, wherein the valuation basic table is the 2008 VBT table.

94. The system of claim 91, wherein the valuation basic table is selected based on a relative risk ratio.

95. The system of claim 69, wherein the mortality information is based on information collected from Medicare data.

96. The system of claim 69, further comprising transmitting the value to a remote computer system to enable the remote computer system to underwrite a loan to the insured using the life insurance policy as collateral.

97. The system of claim 96, wherein the remote computer system is operated by a banking institution.

98. The system of claim 96, wherein the loan is a mortgage.

99. The system of claim 96, wherein the loan is to refinance an existing mortgage.

100. The system of claim 96, wherein the loan is a personal loan.

101. The system of claim 96, wherein the remote computer is operated by a health care provider.

102. The system of claim 101, wherein the proceeds will be used to pay for health care services.
